(19) United States
(12) Patent Application Publication
(10) Pub. No.: US 2006/0029842 A1
(43) Pub. Date: Feb. 9, 2006

(54) Fuel cell system

(76) Inventors: Masaaki Konoto, Kyoto City (JP); Masaya Fujii, Toyonaka City (JP); Kazuhiro Seo, Hirakata City (JP)

Correspondence Address: MCDERMOTT WILL & EMERY LLP, 600 13TH STREET, N.W., WASHINGTON, DC, 20005-3096, US

(21) Appl. No.: 11/193,620

(22) Filed: Aug. 1, 2005

(30) Foreign Application Priority Data
Aug. 6, 2004 (JP) 2004-230449

(51) Int. Cl. H01M 8/00; H01M 2/02; H01M 8/04

(52) U.S. Cl. 429/22; 429/12; 429/34

(57) ABSTRACT

A fuel cell system according to the invention comprises a fuel feeder, a fuel cell stack, a mode control circuit, a bidirectional DC/DC converter, and an electric storage device. The fuel feeder supplies the fuel cell stack with fuel required for the fuel cell stack to generate a predetermined electric power. When the electric power outputted from the fuel cell stack is larger than the load electric power, the mode control circuit makes the bidirectional DC/DC converter perform an operation of charging the electric storage device using the electric power outputted from the fuel cell stack. When the electric power outputted from the fuel cell stack is smaller than the load electric power, the mode control circuit makes the bidirectional DC/DC converter perform an operation of converting the output voltage of the electric storage device into a predetermined voltage and then outputting it. The predetermined voltage is set approximately equal to the output voltage of the fuel cell stack, and the fuel cell stack is controlled to carry out a fixed output at the predetermined electric power.

This application is based on Japanese Patent Application No. 2004-230449 filed on Aug. 6, 2004, the contents of which are hereby incorporated by reference.

### BACKGROUND OF THE INVENTION

1. Field of the Invention

The present invention relates to a fuel cell system built as a system in which a fuel cell and an electric storage device are provided in parallel.

2. Description of Related Art

In recent years, there have been developed various types of fuel cell systems built as a system in which a fuel cell and a rechargeable battery, which is an electric storage device, are provided in parallel (for example, see Japanese Patent Application Laid-Open No. 2004-71260). Generally, in the fuel cell system built as a system in which a fuel cell and a rechargeable battery are provided in parallel, the fuel cell is supplied with a predetermined amount of fuel at regular intervals. In this system, the electric power that can be extracted from the fuel cell is roughly proportional to the amount of reacted fuel. The amount of reacted fuel varies with the electric power required by the load, and the fuel that remains unreacted is recovered and reused. When the electric power extracted from the fuel cell does not satisfy the power requirement of the load, the rechargeable battery supplies supplementary electric power to the load.

However, in the system described above, power loss occurs when the unreacted fuel is recovered. This reduces efficiency of the fuel cell system if the electric power generated by the fuel cell is small relative to the amount of supplied fuel.

To solve this problem, there is a method of controlling the amount of supplied fuel depending on the electric power required by the load so as not to leave any unreacted fuel.

However, the method of controlling the amount of supplied fuel depending on the electric power required by the load so as not to leave any unreacted fuel requires high-speed control to deal with a transient load change. Furthermore, this method requires high-precision control to ensure that no fuel is left unreacted. This makes the control complicated.

### SUMMARY OF THE INVENTION

An object of the present invention is to provide a fuel cell system that offers high efficiency and that can simplify the control.

In order to achieve the above object, a fuel cell system according to the present invention is built as a system in which a fuel cell and an electric storage device are provided in parallel. The fuel cell system includes the fuel cell, a fuel feeder, the electric storage device, a bidirectional DC/DC converter, a load electric power detector, and a controller. The fuel feeder supplies the fuel cell with fuel required for the fuel cell to generate a predetermined electric power. The bidirectional DC/DC converter selectively performs an operation of converting the output voltage of the electric storage device into a predetermined voltage and then outputting the predetermined voltage, or an operation of charging the electric storage device using the electric power outputted from the fuel cell. The load electric power detector detects the load electric power, that is, the electric power required of the fuel cell system by an external load. The controller receives the detection result of the load electric power detector so that: if the controller, while making the bidirectional DC/DC converter perform the operation of converting the output voltage of the electric storage device into the predetermined voltage and then outputting the predetermined voltage, finds that the electric power outputted from the fuel cell is larger than the load electric power, the controller makes the bidirectional DC/DC converter switch into the operation of charging the electric storage device using the electric power outputted from the fuel cell; if the controller, while making the bidirectional DC/DC converter perform the operation of converting the output voltage of the electric storage device into the predetermined voltage and then outputting the predetermined voltage, finds that the electric power outputted from the fuel cell is smaller than the load electric power, the controller makes the bidirectional DC/DC converter continue the operation of converting the output voltage of the electric storage device into the predetermined voltage and then outputting the predetermined voltage; if the controller, while making the bidirectional DC/DC converter perform the operation of charging the electric storage device using the electric power outputted from the fuel cell, finds that the electric power outputted from the fuel cell is larger than the load electric power, the controller makes the bidirectional DC/DC converter continue the operation of charging the electric storage device using the electric power outputted from the fuel cell; and, if the controller, while making the bidirectional DC/DC converter perform the operation of charging the electric storage device using the electric power outputted from the fuel cell, finds that the electric power outputted from the fuel cell is smaller than the load electric power, the controller makes the bidirectional DC/DC converter switch into the operation of converting the output voltage of the electric storage device into the predetermined voltage and then outputting the predetermined voltage. The predetermined voltage is made approximately equal to the output voltage of the fuel cell, and the fuel cell is controlled so as to carry out a fixed output at the predetermined electric power. Used as the above-described electric storage device is, for example, a rechargeable battery or an electric double layer capacitor.

With this configuration, if the electric power outputted from the fuel cell is larger than the load electric power, in other words, if surplus electric power is being generated, the surplus electric power is charged in the electric storage device, and, if the electric power outputted from the fuel cell is smaller than the load electric power, in other words, if there is a shortage of electric power, the electric power shortage is compensated for by the electric power outputted from the electric storage device, whereby the fuel cell is controlled so as to carry out a fixed output at the predetermined electric power. This helps realize a highly efficient fuel cell. Moreover, the control performed by the controller to make the bidirectional DC/DC converter switch between different operations can easily deal with a transient load change. Thus, the fuel cell system configured as described above does not require high-precision and high-speed fuel control, and thus helps simplify the control.

From the viewpoint of reducing the possibility that the electric storage device becomes fully charged or empty, preferably, the amount of fuel supplied to the fuel cell from the fuel feeder is made variable, and, as the predetermined electric power and the predetermined voltage, a plurality of different electric powers and different voltages can be set. For example, the amount of fuel supplied to the fuel cell from the fuel feeder may be varied according to the detection result of the load electric power detector.

In either of the configurations described above, the fuel cell system may further include an output electric power checker and a supply fuel amount controller. The output electric power checker checks whether or not electric power is being supplied to the external load from the bidirectional DC/DC converter. The supply fuel amount controller receives the detection result of the load electric power detector and the check result of the output electric power checker, and, if electric power is being supplied to the external load from the bidirectional DC/DC converter even though the load electric power is smaller than the predetermined electric power, the supply fuel amount controller controls the fuel feeder to supply fuel to the fuel cell.

With this configuration, when electric power is being supplied to the external load from the bidirectional DC/DC converter even though the load electric power is smaller than the predetermined electric power, fuel is supplied to the fuel cell. This helps overcome the fuel shortage in the fuel cell.

In any of the configurations of the fuel cell system described above, the fuel feeder may operate with electric power derived from the output of the fuel cell system. This eliminates the need to additionally provide an electric power source for the fuel feeder.

### BRIEF DESCRIPTION OF THE DRAWINGS

FIG. 1 is a block diagram showing an example of the configuration of a fuel cell system according to the invention;

FIG. 2 is a graph showing the current-voltage characteristic and the current-power characteristic of the fuel cell stack;

FIG. 3 is a diagram showing an example of the configuration of the bidirectional converter provided in the fuel cell system according to the invention;

FIG. 4 is a block diagram showing a modified example of the fuel cell system shown in FIG. 1;

FIG. 5 is a graph showing the current-voltage characteristic and the current-power characteristic of the fuel cell stack;

FIG. 6 is a block diagram showing another example of the configuration of the fuel cell system according to the invention; and

FIG. 7 is a graph showing the current-voltage characteristic and the current-power characteristic of the fuel cell stack.

### DETAILED DESCRIPTION OF PREFERRED EMBODIMENTS

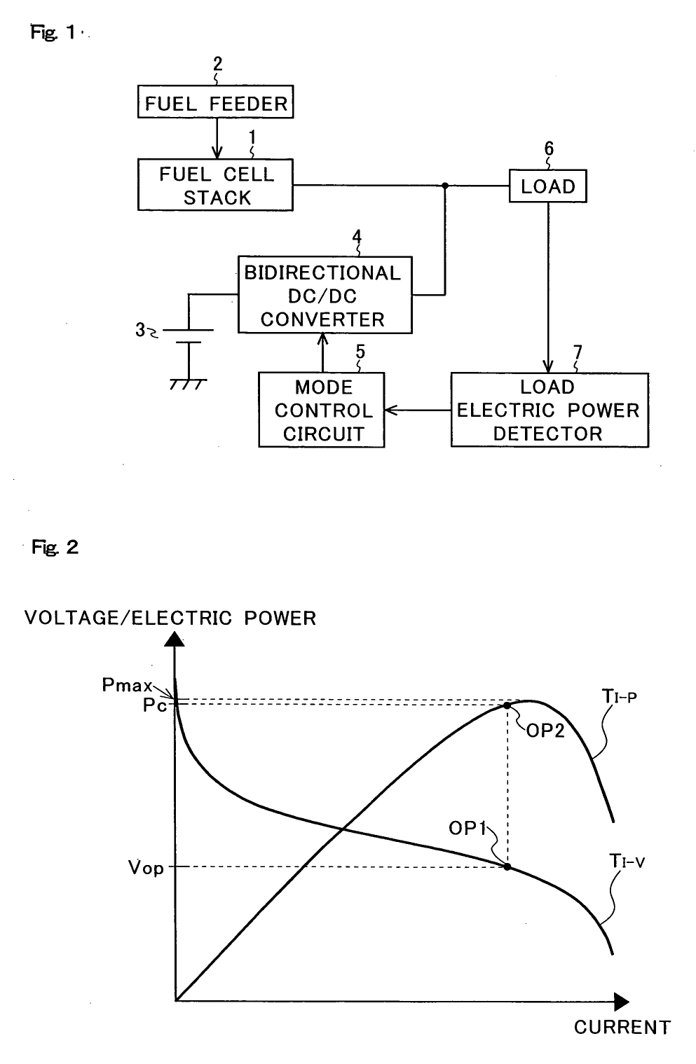

FIG. 1 shows an example of the configuration of a fuel cell system according to the invention, and FIG. 2 shows the current-voltage characteristic curve T_{1-V} and the current-power characteristic curve T_{1-P} of the fuel cell stack 1 provided in the fuel cell system according to the invention shown in FIG. 1.

The fuel cell system according to the invention shown in FIG. 1 is built as a system in which a fuel cell and an electric storage device are provided in parallel. The fuel cell system comprises: a fuel cell stack 1; a fuel feeder 2; a rechargeable battery 3 that is an electric storage device; a bidirectional DC/DC converter 4; a mode control circuit 5; and a load electric power detector 7.

The fuel feeder 2 supplies the fuel cell stack 1 with a fixed amount of fuel at regular intervals. The fuel cell stack 1 is controlled so as to carry out a fixed output, namely an electric power Pc equal to or slightly lower than the maximum electric power Pmax shown in FIG. 2, irrespective of the electric power required by the load 6.

The positive electrode of the rechargeable battery 3 is connected to one end of the bidirectional DC/DC converter 4. The output terminal of the fuel cell stack 1 and the other end of the bidirectional DC/DC converter 4 are connected together, and are then connected to the load 6.

The load electric power detector 7 detects the electric power required by the load 6 of the fuel cell system (hereinafter, referred to as the load electric power), and outputs the detection result to the mode control circuit 5. For example, when the load 6 is a DC/DC converter, the output voltage of the DC/DC converter is fixed at a predetermined set value. This permits the load electric power detector 7 to detect the load electric power by detecting the output current of the DC/DC converter.

The mode control circuit 5 controls the mode of the bidirectional DC/DC converter 4 based on the output of the load electric power detector 7.

The fuel feeder 2 operates with electric power derived from the output of the fuel cell system. That is, although the fuel feeder 2 and the load 6 are illustrated as separate blocks in FIG. 1 for the sake of convenience, in reality the fuel feeder 2 is part of the load 6.

The bidirectional DC/DC converter 4 is configured so as to make the rechargeable battery 3 charged and discharged. In discharge mode, the bidirectional DC/DC converter 4 steps up the output voltage of the rechargeable battery 3, and then outputs it to the load 6; in charge mode, the bidirectional DC/DC converter 4 steps down the voltage supplied from the fuel cell stack 1, and then outputs it to the rechargeable battery 3. The output voltage set value Vop of the bidirectional DC/DC converter 4 in discharge mode is made equal to the output voltage of the fuel cell stack 1 operating at operating points OP1 and OP2.

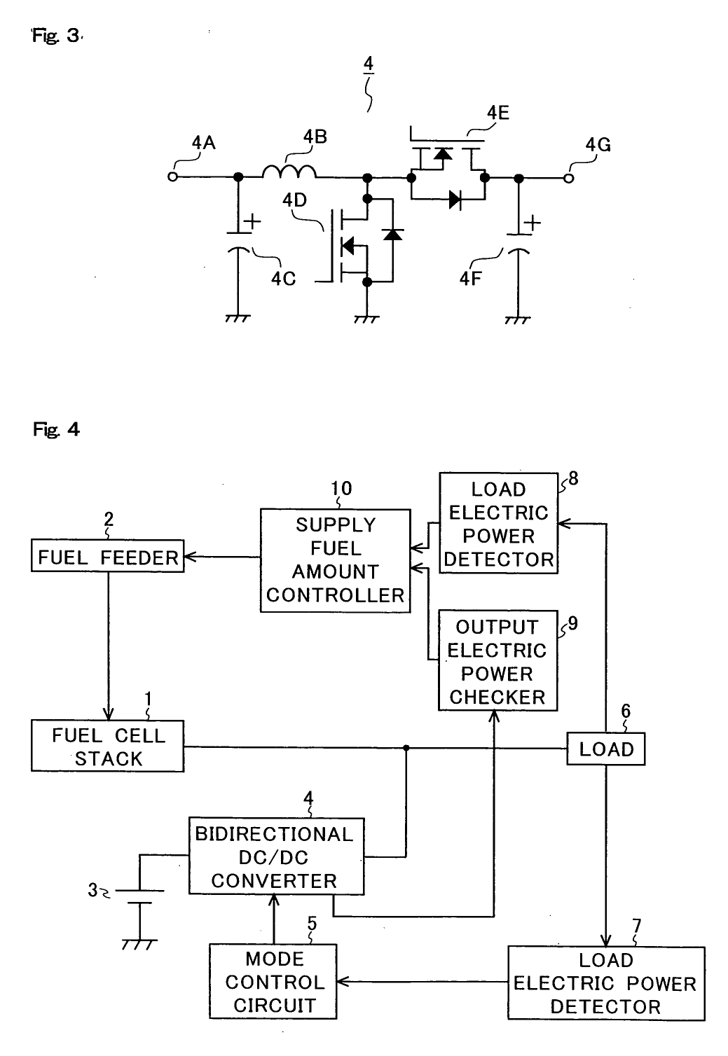

Now, an example of the configuration of the bidirectional DC/DC converter 4 will be described with reference to FIG. 3. The bidirectional DC/DC converter 4 includes: a terminal 4A connected to the rechargeable battery 3 (not shown in FIG. 3); a coil 4B, a capacitor 4C; a discharge switching device 4D; a charge switching device 4E; a capacitor 4F; and a terminal 4G connected to the fuel cell stack 1 (not shown in FIG. 3) and to the load 6 (not shown in FIG. 3). The discharge switching device 4D is composed of: a MOSFET (metal-oxide-semiconductor field-effect transistor); and a diode with its cathode toward the coil 4B. The charge switching device 4E is composed of: a MOSFET; and a diode with its anode toward the coil 4B. The terminal 4A is connected to one end of the coil 4B and to one end of the capacitor 4C. The other end of the coil 4B is connected to one end of the discharge switching device 4D and to one end of the charge switching device 4E. The other ends of the capacitor 4C and of the discharge switching device 4D are at the same potential as the negative electrodes of the rechargeable battery 3 and of the fuel cell stack 1. The other end of the charge switching device 4E is connected to one end of the capacitor 4F and to the terminal 4G. The other end of the capacitor 4F is at the same potential as the negative electrodes of the rechargeable battery 3 and of the fuel cell stack 1.

In discharge mode, while the MOSFET constituting the discharge switching device 4D is on and the MOSFET constituting the charge switching device 4E is off, the output voltage of the rechargeable battery 3 (not shown in FIG. 3) causes the coil 4B to accumulate energy. Then, the MOSFET constituting the discharge switching device 4D is turned off and the MOSFET constituting the charge switching device 4E is turned on, so that the energy accumulated in the coil 4B, passing via the source-drain of the MOSFET constituting the charge switching device 4E and the diode serving as a rectifying device, is stabilized by the capacitor 4F and is then supplied to the load 6 (not shown in FIG. 3) connected to the terminal 4G. In this manner, step-up discharging is performed.

On the other hand, in charge mode, while the MOSFET constituting the charge switching device 4E is on and the MOSFET constituting the discharge switching device 4D is off, the electric power outputted from the fuel cell stack 1 (not shown in FIG. 3) is supplied, via the coil 4B, to the rechargeable battery 3 (not shown in FIG. 3) to charge it. Then, the MOSFET constituting the charge switching device 4E is turned off and the MOSFET constituting the discharge switching device 4D is turned on, so that a current flows via the capacitor 4C and also via the source-drain of the MOSFET constituting the discharge switching device 4D and the diode serving as a rectifying device. This cancels out the energy accumulated in the coil 4B. In this manner, step-down charging is performed.

Now, the description of the fuel cell system shown FIG. 1 will be continued. When the fuel cell system is started, the mode control circuit 5 brings the bidirectional DC/DC converter 4 into discharge mode. The mode control circuit 5 has previously stored, in an internal memory (not shown) provided therein, the value of the electric power Pc outputted from the fuel cell stack 1 operating at the operating points OP1 and OP2. The mode control circuit 5 compares the stored value with the output of the load electric power detector 7 to judge whether the electric power outputted from the fuel cell stack 1 is larger than the load electric power or not.

If the electric power outputted from the fuel cell stack 1 is found to be larger than the load electric power when the bidirectional DC/DC converter 4 is in discharge mode, in other words, if surplus electric power is found to be being generated, the mode control circuit 5 brings the bidirectional DC/DC converter 4 into charge mode. By contrast, if the electric power outputted from the fuel cell stack 1 is found to be smaller than the load electric power when the bidirectional DC/DC converter 4 is in discharge mode, in other words, if there is found to be a shortage of electric power, the mode control circuit 5 maintains the discharge mode of the bidirectional DC/DC converter 4. Note that if the electric power outputted from the fuel cell stack 1 is equal to the load electric power when the bidirectional DC/DC converter 4 is in discharge mode, the mode control circuit 5 may maintain the discharge mode of the bidirectional DC/DC converter 4, or bring it into charge mode.

On the other hand, if the electric power outputted from the fuel cell stack 1 is found to be larger than the load electric power when the bidirectional DC/DC converter 4 is in charge mode, in other words, if surplus electric power is found to be being generated, the mode control circuit 5 maintains the charge mode of the bidirectional DC/DC converter 4. By contrast, if the electric power outputted from the fuel cell stack 1 is found to be smaller than the load electric power when the bidirectional DC/DC converter 4 is in charge mode, in other words, if there is found to be a shortage of electric power, the mode control circuit 5 brings the bidirectional DC/DC converter 4 into discharge mode. Note that if the electric power outputted from the fuel cell stack 1 is equal to the load electric power when the bidirectional DC/DC converter 4 is in charge mode, the mode control circuit 5 may maintain the charge mode of the bidirectional DC/DC converter 4, or bring it into discharge mode.

With the above-described control performed by the mode control circuit 5, surplus electric power, if any, is charged in the rechargeable battery 3, and electric power shortage, if any, is compensated for by the electric power outputted from the rechargeable battery 3. This permits the fuel cell stack 1 to carry out a fixed output at the electric power Pc, and thereby helps realize a highly efficient fuel cell. Furthermore, the switching between discharge mode and charge mode performed by the mode control circuit 5 can easily deal with a transient load change. Thus, the fuel cell system according to the invention shown in FIG. 1 does not require high-precision and high-speed fuel control, and thus helps simplify the control.

From the viewpoint of enhancing efficiency in a fuel cell system, the fuel cell system according to the invention shown in FIG. 1 is not provided with a blocking diode whose anode is connected to the output terminal of the fuel cell stack 1. This causes no problem at all because, unlike in the rechargeable battery, reverse charging (charging from a higher voltage battery to a lower voltage battery) does not occur in the fuel cell stack 1. On the contrary, the absence of the blocking diode allows the fuel cell system to enhance efficiency because it prevents power loss that occurs in the blocking diode. Note that, although the efficiency of the fuel cell system is reduced, the fuel cell system may be provided with the blocking diode.

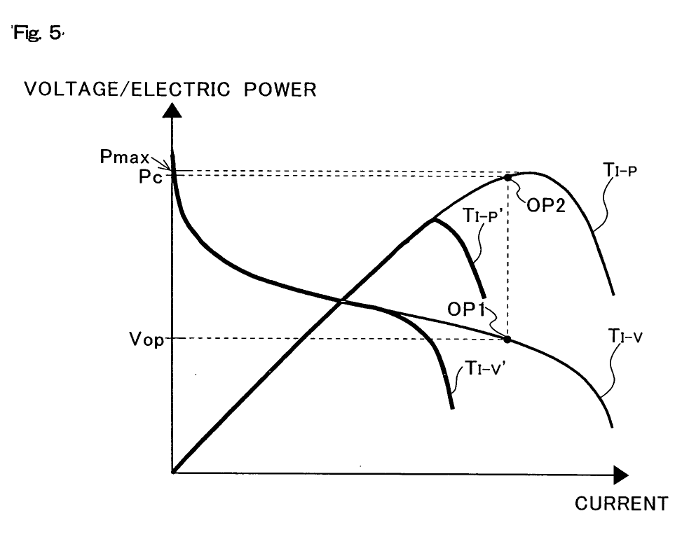

As shown in FIG. 4, the fuel cell system shown in FIG. 1 may be additionally provided with: a load electric power detector 8; an output electric power checker 9; and a supply fuel amount controller 10.

Even when the fuel feeder 2 supplies the fuel cell stack 1 with an amount of fuel equivalent to the amount of reacted fuel required for the fuel cell stack 1 to operate at the operating points OP1 and OP2 shown in FIG. 2, the concentration of fuel varies due to loss in the recovery of unreacted fuel, evaporation resulting from an increase in the ambient temperature, and the like. When the fuel concentration becomes low, the current-voltage characteristic curve and the current-power characteristic curve of the fuel cell stack 1 change as indicated by T_{1-V}′ and T_{1-P}′, respectively, in FIG. 5. In this state, the fuel cell stack 1 cannot operate at the operating points OP1 and OP2. This state is what is called fuel shortage.

The load electric power detector 8 detects the load electric power, and then outputs the detection result to the supply fuel amount controller 10. For example, when the load 6 is a DC/DC converter, the output voltage thereof is fixed at a predetermined set value. This permits the load electric power detector 8 to detect the load electric power by detecting the output current of the DC/DC converter.

The output electric power checker 9 checks whether electric power is being supplied to the load 6 from the bidirectional DC/DC converter 4 or not, and then outputs the check result to the supply fuel amount controller 10. The output electric power checker 9 detects the input current or the output current of the bidirectional DC/DC converter 4 in discharge mode. When the detected current value is not equal to zero, electric power is recognized to be being supplied to the load 6 from the bidirectional DC/DC converter 4. By contrast, when the detected current value is equal to zero, the electric power is recognized not to be being supplied to the load 6 from the bidirectional DC/DC converter 4.

If electric power is being supplied to the load 6 from the bidirectional DC/DC converter 4 even though the load electric power is smaller than Pc (the value of the electric power outputted from the fuel cell stack 1 when it is supplied with sufficient fuel), the supply fuel amount controller 10 judges that the fuel cell receives insufficient fuel supply, and thus controls the fuel feeder 2 to supply fuel to the fuel cell stack 1. The smaller the load electric power is when the bidirectional DC/DC converter 4 starts to supply electric power to the load 6, the larger amount of fuel the fuel cell runs short of. Thus, it is preferable to increase the amount of supplied fuel accordingly.

If electric power is being supplied to the load 6 from the bidirectional DC/DC converter 4 even though the load electric power is smaller than Pc, the supply fuel amount controller 10 judges that the fuel cell has insufficient fuel supply, and thus controls the fuel feeder 2 to supply fuel to the fuel cell stack 1. This helps overcome the fuel shortage in the fuel cell.

Even a fuel cell system provided with a blocking diode may be additionally provided with a load electric power detector 8, an output electric power checker 9, and a supply fuel amount controller 10 as described above to overcome fuel shortage in the fuel cell. However, from the viewpoint of enhancing efficiency in a fuel cell system, it is preferable that a fuel cell system be configured as shown in FIG. 4 and do away with a blocking diode. Furthermore, since the load electric power detector 7 and the load electric power detector 8 have the same function, it is preferable that they be integrated into one.

In the above-described fuel cell system shown in FIG. 1, the rechargeable battery 3 will eventually become fully charged if the load electric power persistently stays smaller than the electric power outputted from the fuel cell stack 1; by contrast, the rechargeable battery 3 will eventually become empty if the load electric power persistently stays larger than the electric power outputted from the fuel cell stack 1. If surplus electric power is generated when the rechargeable battery 3 is fully charged, it cannot be charged in the rechargeable battery 3. As a result, the fuel cell stack 1 cannot continue to operate at the operating points OP1 and OP2 shown in FIG. 2. This reduces the output electric power of the fuel cell stack 1, producing unreacted fuel. Disadvantageously, however, recovering the unreacted fuel produces power loss. On the other hand, if there is a shortage of electric power when the rechargeable battery 3 is empty, the electric power shortage cannot be compensated for by the electric power outputted from the rechargeable battery 3.

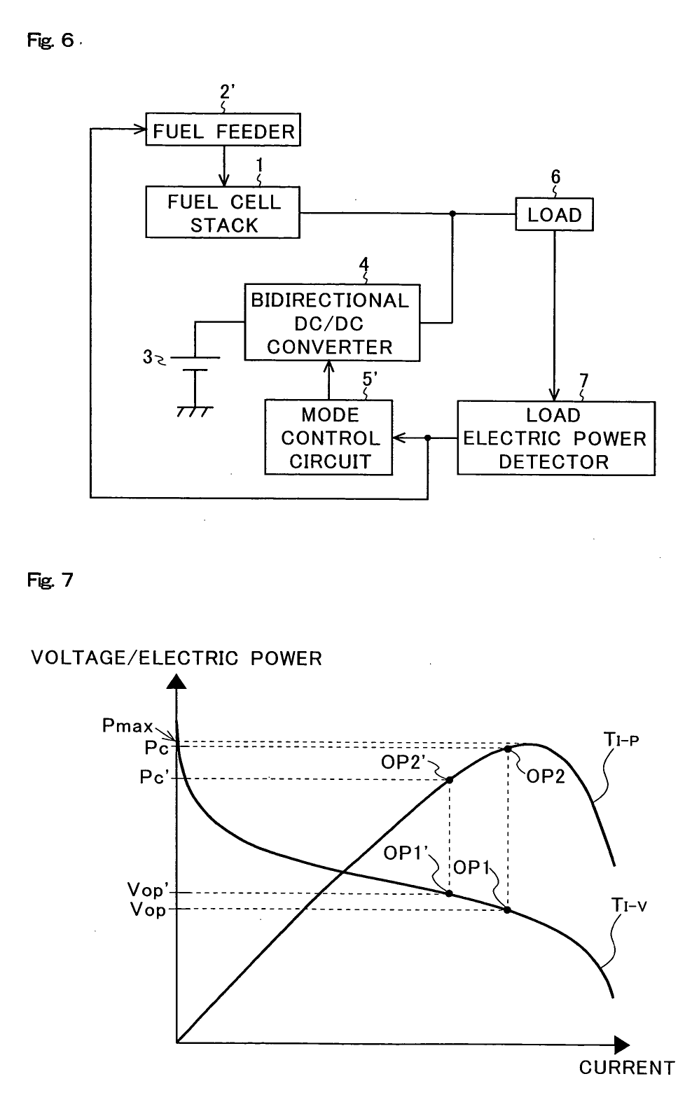

To overcome these problems, another fuel cell system according to the invention shown in FIG. 6 is so designed as to reduce the possibility that the rechargeable battery becomes fully charged or empty. Note that, in FIG. 6, such members as are found also in FIG. 1 are identified with common reference numerals, and their detailed descriptions will be omitted.

The fuel cell system shown in FIG. 6 differs from the fuel cell system shown in FIG. 1 in that the fuel feeder 2 is replaced with a fuel feeder 2′ and the mode control circuit 5 is replaced with a mode control circuit 5′.

The fuel feeder 2′ receives the output of the load electric power detector 7. When the load electric power is larger than a previously set threshold value, the fuel feeder 2′ supplies the fuel cell stack 1 with an amount of fuel equivalent to the amount of reacted fuel required for the fuel cell stack 1 to operate at the operating points OP1 and OP2 shown in FIG. 7. When the load electric power is equal to or smaller than the previously set threshold value, the fuel feeder 2′ supplies the fuel cell stack 1 with an amount of fuel equivalent to the amount of reacted fuel required for the fuel cell stack 1 to operate at the operating points OP1′ and OP2′. This permits the fuel cell stack 1 to carry out a fixed output at an electric power Pc or Pc′, irrespective of the electric power required by the load 6.

The mode control circuit 5′ differs from the mode control circuit 5 only in that the former additionally performs the following operations. When the load electric power is larger than the previously set threshold value, the mode control circuit 5′ sets the output voltage of the bidirectional DC/DC converter 4 in discharge mode at a set value Vop (which is equal to the output voltage value of the fuel cell stack 1 operating at the operating points OP1 and OP2). On the other hand, when the load electric power is equal to or smaller than the previously set threshold value, the mode control circuit 5′ sets the output voltage of the bidirectional DC/DC converter 4 in discharge mode at a set value Vop′ (which is equal to the output voltage value of the fuel cell stack 1 operating at the operating points OP1′ and OP2′).

In the fuel cell system shown in FIG. 6, when the load electric power is equal to or smaller than a threshold value, the fuel cell stack 1 is controlled so as to carry out a fixed output at the smaller electric power (Pc′). This reduces the possibility that the rechargeable battery 3 becomes fully charged. Furthermore, in the fuel cell system shown in FIG. 6, when the load electric power is larger than the threshold value, the fuel cell stack 1 is controlled so as to carry out a fixed output at the larger electric power (Pc). This reduces the possibility that the rechargeable battery 3 becomes empty.

A detector for detecting the fully charged state of the rechargeable battery 3 may be additionally provided, so that, when the detector detects the fully charged state of the rechargeable battery 3, the fuel feeder 2′ reduces the amount of fuel supplied to the fuel cell stack 1, and the mode control circuit 5′ raises the set value of the output voltage of the bidirectional DC/DC converter 4 in discharge mode.

A detector for detecting the empty state of the rechargeable battery 3 may be additionally provided, so that, when the detector detects the empty state of the rechargeable battery 3, the fuel feeder 2′ increases the amount of fuel supplied to the fuel cell stack 1, and the mode control circuit 5′ lowers the set value the output voltage of the bidirectional DC/DC converter 4 in discharge mode.

Although, like the fuel cell system shown in FIG. 1, the fuel cell system shown in FIG. 6 is not provided with a blocking diode whose anode would be connected to the output terminal of the fuel cell stack 1, in practice, it may be provided with one.

Furthermore, like the fuel cell system shown in FIG. 1, the fuel cell system shown in FIG. 6 may be additionally provided with a load electric power detector 8, an output electric power checker 9, and a supply fuel amount controller 10.

Obviously, many modifications and variations of the present invention are possible in light of the above teachings. It is therefore to be understood that within the scope of the appended claims, the invention may be practiced other than as specifically described. For example, in the fuel cell system shown in FIG. 6, one of two different amounts of fuel can be supplied to the fuel cell stack 1 from the fuel feeder 2′; in practice, however, one of three or more different amounts of fuel may be supplied instead. Furthermore, in the embodiments described above, a rechargeable battery is used as an electric storage device. In practice, however, any other type of electric storage device (e.g., an electric double layer capacitor) may be used instead.

What is claimed is:

1. A fuel cell system built as a system in which a fuel cell and an electric storage device are provided in parallel, the fuel cell system comprising:
the fuel cell;
a fuel feeder;
the electric storage device;
a bidirectional DC/DC converter;
a load electric power detector; and
a controller;
wherein the fuel feeder supplies the fuel cell with fuel required for the fuel cell to generate a predetermined electric power,
wherein the bidirectional DC/DC converter selectively performs an operation of converting an output voltage of the electric storage device into a predetermined voltage and then outputting the predetermined voltage, or an operation of charging the electric storage device using an electric power outputted from the fuel cell,
wherein the load electric power detector detects a load electric power that is an electric power required of the fuel cell system by an external load,
wherein the controller receives a detection result of the load electric power detector so that,
if the controller, while making the bidirectional DC/DC converter perform the operation of converting the output voltage of the electric storage device into the predetermined voltage and then outputting the predetermined voltage, finds that the electric power outputted from the fuel cell is larger than the load electric power, the controller makes the bidirectional DC/DC converter switch into the operation of charging the electric storage device using the electric power outputted from the fuel cell,
if the controller, while making the bidirectional DC/DC converter perform the operation of converting the output voltage of the electric storage device into the predetermined voltage and then outputting the predetermined voltage, finds that the electric power outputted from the fuel cell is smaller than the load electric power, the controller makes the bidirectional DC/DC converter continue the operation of converting the output voltage of the electric storage device into the predetermined voltage and then outputting the predetermined voltage,
if the controller, while making the bidirectional DC/DC converter perform the operation of charging the electric storage device using the electric power outputted from the fuel cell, finds that the electric power outputted from the fuel cell is larger than the load electric power, the controller makes the bidirectional DC/DC converter continue the operation of charging the electric storage device using the electric power outputted from the fuel cell, and,
if the controller, while making the bidirectional DC/DC converter perform the operation of charging the electric storage device using the electric power outputted from the fuel cell, finds that the electric power outputted from the fuel cell is smaller than the load electric power, the controller makes the bidirectional DC/DC converter switch into the operation of converting the output voltage of the electric storage device into the predetermined voltage and then outputting the predetermined voltage, and
wherein the predetermined voltage is made approximately equal to an output voltage of the fuel cell, and the fuel cell is controlled so as to carry out a fixed output at the predetermined electric power.

2. The fuel cell system according to claim 1,
wherein an amount of fuel supplied to the fuel cell from the fuel feeder is made variable, and, as said predetermined electric power and said predetermined voltage, a plurality of different electric powers and different voltages can be set.

3. The fuel cell system according to claim 2,
wherein the amount of fuel supplied to the fuel cell from the fuel feeder is varied according to a detection result of the load electric power detector.

4. The fuel cell system according to claim 1, further comprising:
an output electric power checker; and
a supply fuel amount controller,
wherein the output electric power checker checks whether or not electric power is being supplied to the external load from the bidirectional DC/DC converter, and
wherein the supply fuel amount controller receives: a detection result of the load electric power detector and a check result of the output electric power checker, and, if electric power is being supplied to the external load from the bidirectional DC/DC converter even though the load electric power is smaller than the predetermined electric power, the supply fuel amount controller controls the fuel feeder to supply fuel to the fuel cell.

5. The fuel cell system according to claim 1,
wherein the fuel feeder operates with electric power derived from an output of the fuel cell system.

6. The fuel cell system according to claim 1,
wherein the electric storage device is a rechargeable battery.
